(19) United States
(12) Patent Application Publication
(10) Pub. No.: US 2009/0257805 A1
(43) Pub. Date: Oct. 15, 2009

(54) Digital Raised Printing Using Phase Change Inkjet Technology

(76) Inventor: Michael Gerard Reynolds, Califon, NJ (US)

Correspondence Address: MICHAEL REYNOLDS, 67 TURTLEBACK ROAD, CALIFON, NJ, 07830-3510, US

(21) Appl. No.: 12/101,112

(22) Filed: Apr. 10, 2008

(51) Int. Cl. B41J 3/32; B41J 2/01

(52) U.S. Cl. 400/109.1; 347/2

(57) ABSTRACT

A method for creating raised and special purpose printing effects using phase change inkjet technology (also known as a solid ink jet) is provided. The method includes the steps of printing a primary phase change ink jet image (32) on a substrate (24) using an offset deposition process followed by a secondary phase change ink jet deposition (15) directly jetted on top of the primary image area selected for the printing effects. The amount of secondary material to be deposited corresponds to the area selected for the printing effects and the height of the raised area relative to the substrate (24) on which the secondary phase change ink material (15) is deposited.

### FIELD OF THE INVENTION

The present invention relates to the use of three-dimensional printing techniques in the printing of special purpose finishes on a substrate, such as paper, business cards, greeting cards or packaging using phase change ink-jet techniques.

### BACKGROUND OF THE INVENTION

Raised printing, also known as thermography, is the deposit of a powdered polymer on top of an ink image on a substrate. Heat is applied until the polymer grains film out causing the words or images to have a height above the plane of the substrate. The grain diameter sets the height of the raised printing since the grain layer is one grain thickness. This creates the effect of the words or images standing out from the page in order to emphasize their content.

Conventional raised printing is achieved today using traditional printing methods coupled with thermography machines. Thermography machines are constructed with three sections connected by a through conveyor. The first section applies powdered polymer to the entire sheet followed by a gentle vacuuming to remove the excess powder from the non imaged and dry ink areas. The areas selected for raised printing are printed with inks that do not contain dryers or hardeners so that they remain wet during the application of powder. This ink will be dried or hardened later during the heating process. The powdering systems sometimes cause dusty conditions in the printing shop. The vacuum system has a throughput limit on the order of 90 to 100 feet per minute. The sheet is conveyed through a radiant oven system and heated to about 350° F. The heating process takes on the order of 2.5 to 3 seconds. During this time, the substrate (usually a paper product) has a peak in IR radiant absorption at the frequency (temperature) used in this process. Through conduction from the contact with the paper, the powder temperature rapidly increases and starts filming at the edges of the selected raised printing areas. When the center of the largest filmed areas reaches a sufficient quality level, the process speed adjustment and heater intensity are such that the product will be exiting the heater. After the polymer filming is at the proper quality and before combustion occurs, the sheet is immediately run into a convection cooling section where the filming action is stopped at that quality level. The heat of fusion and filming for the polymer grains is only a percent or two of the total heat generated by the heating system. The heat from the oven system is released into the production environment. Occasionally there are fires during production. Various properties of the substrate are degraded during this process because the heat needed to film the polymer is conducted through the substrate to the polymer.

Ink-jet printing is the jetting of liquid ink through a row of nozzles of an inkjet head to create an image on a flat substrate, such as paper. In standard two dimensional printing, the ink-jet printer selectively jets ink dots onto a substrate by displacing the substrate relative to the inkjet print head in one direction during the actuation of an array of ink-jet nozzles. Some inkjets use a solid ink also referred to as phase change ink. In these inkjet heads a melted hot melt ink is jetted as a liquid that solidifies on contact with the substrate. Three-dimensional printing, which works by jetting hot melt or phase change ink in layers, is a process used for building three-dimensional objects.

### SUMMARY OF THE INVENTION

The present invention provides a system and method for using a phase change inkjet printing head having at least one row of inkjet nozzles for the printing on paper or other flat media of raised letters, words or images in order to emphasize their content or for use in tactile communication, such as but not limited to, Braille printing. The present invention provides for the achievement of the raised printing effect in individualized documents produced on standard word processing software or other imaging software operated on personal computing systems, and using a phase change inkjet type of printing device. The present invention can also be used with typical software used for order entry in a business card or other commercial printing operations.

There is thus provided in accordance with a preferred embodiment of the invention, a method for creating raised and special printing effects using phase change or solid ink inkjet technology. The method includes the steps of printing a primary phase change ink jet image on a substrate using an offset deposition process followed by a secondary phase change ink jet deposition directly jetted on top of the image area selected for the printing effects. The amount of secondary material to be deposited corresponds to the area selected for the printing effects and the height of the raised area relative to the substrate on which the phase change ink material is deposited.

Furthermore, in accordance with a preferred embodiment of the invention, the step of secondary depositing includes selectively adjusting the output from each of a plurality of inkjet nozzles, to control the amount of material dispensed from each nozzle.

Furthermore, in accordance with a preferred embodiment of the invention, the step of secondary depositing includes jetting the phase change material in layers of pre-determined thickness.

Furthermore, in accordance with a preferred embodiment of the invention, the phase change material in the secondary depositing is a clear or transparent material allowing the raised effect to have the tone and tint of the underlying primary deposition or image.

Furthermore, in accordance with a preferred embodiment of the invention, the phase change material in the secondary depositing is a clear or transparent material allowing the image of the underlying primary deposition or image to be clearly seen, such as but not limited to, the application of Braille printing on a restaurant menu, a credit card purchase receipt or United States Currency printed by the Bureau of Engraving and Printing.

In addition, in accordance with a preferred embodiment of the invention, the method further includes the mixing of different color jet depositions in the primary and secondary depositions to achieve any color required.

Furthermore, in accordance with a preferred embodiment of the invention, the primary and secondary depositing are both directly jetted onto the substrate without using offset deposition.

Furthermore, in accordance with a preferred embodiment of the invention, the primary image is printed with a printing process that is not a phase change inkjet.

Furthermore, in accordance with a preferred embodiment of the invention, the substrate is initially heated to a temperature below that of the phase change ink to increase the quality of the film surface formed and the adhesion to the substrate.

Furthermore, in accordance with a preferred embodiment of the invention, the invention has an integral business card cutting assembly. A UV radiator may also be included in the construction directly following the jetting heads.

Furthermore, in accordance with a preferred embodiment of the invention, the invention prints patterns with the secondary depositing that is used for tactile communication. This tactile communication could be Braille or other tactile symbols understood by people who are visually impaired. This method of would enable the production of a printed item that can be understood by both people with and without visual impairments.

### DESCRIPTION OF THE PRESENT INVENTION

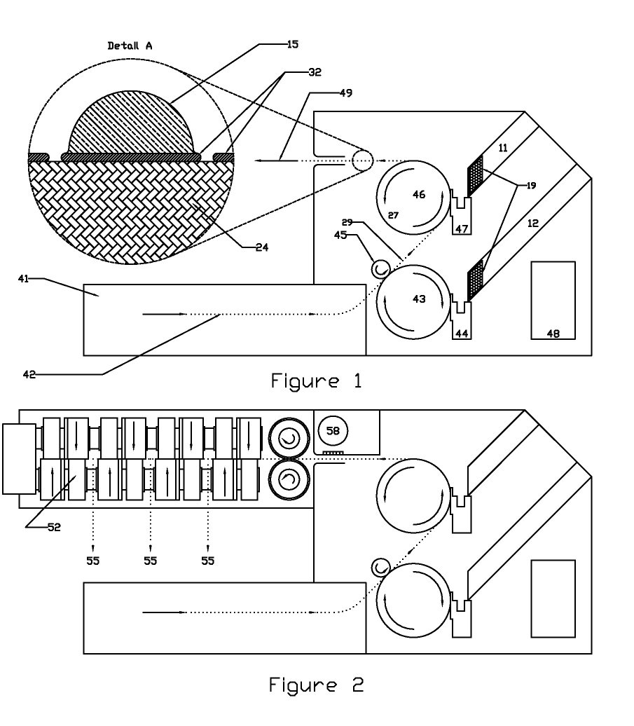

The present invention will be understood and appreciated more fully from the following detailed description taken in conjunction with the appended drawings, FIGS. 1 and 2, which are schematic illustrations of the printing apparatus for raised printing using phase change ink-jet technology.

The apparatus of FIG. 1 includes a primary phase change inkjet head 44 with solid ink feed system 12 and a secondary phase change inkjet head 47 with solid ink feed system 11. Both jet heads have a plurality of nozzles in an array covering the width of the substrate 24 perpendicular to the direction of motion. The solid ink feed systems 11 and 12 melt the solid ink 19 and funnel it into the inkjet head for dispensing. The height of the secondary deposited layer 15 is controllable by selectively adjusting the output from each of the plurality of nozzles in the secondary inkjet head 47.

The primary jetted image 32 is printed by the user of the apparatus via the controller 48, using a computer with word processing or graphics software package, for example. After receiving the print command from the user, the process controller 48 instructs the substrate feed tray 41 to introduce the substrate 24 onto the input path 42. Next, the controller 48 instructs the primary phase change inkjet head 44 to jet the primary image 32. This is achieved by feeding the melt phase ink 19 from the solid ink feed system 12 and selectively adjusting the output from each of the plurality of primary phase change ink-jet 44 nozzles, to control the amount of material dispensed from each nozzle.

The printing apparatus further comprises an offset deposition assembly consisting of offset imaging drum 43 and pressure roller 45. This assembly works with the primary phase change inkjet head 44 wherein the primary jetted image 32 is first applied to the offset imaging drum 43. The offset imaging drum 43 with the primary jetted image 32 on the surface rotates around to contact the substrate 24 wherein the primary jetted image 32 is removed from the offset imaging drum 43 when pressed into the substrate 24 by the pressure roller 45.

The user of the apparatus specifies via the controller 48, using the word processing or graphics software package the areas of the image that are desired to be printed in raised letters, words or images. The user also specifies any other parameters related to the raised image, such as the height of the raised areas, for example, 0.004 inches. All of these parameters are entered initially with the order entry.

The substrate with the impressed primary image 29 is then conveyed to the direct deposition assembly consisting of the secondary phase change inkjet head 47 and direct imaging drum 46. The secondary phase change inkjet head 47 deposits the secondary jetted image 15 directly onto the indicated areas for raised printing.

The process controller 48 instructs the secondary phase change inkjet head 47 to jet the secondary jetted image 15 onto the area of the primary image 32 selected for raised printing. This is achieved by feeding the melt from phase change ink 19 in the solid ink feed system 11 and selectively adjusting the output from each of the plurality of secondary phase change ink-jet 47 nozzles, to control the amount of material dispensed from each nozzle. The amount of material deposited will correspond to the area selected for raised printing and the height of the raised area relative to the fist medium (substrate 24) on which the material will be deposited. The secondary jetted image 15 changes state and solidifies on contact with the substrate 24. The quality of the film surface created on the secondary jetted image 15 can be adjusted by varying a heater 27 integral to the direct imaging drum 46 to gently warm the substrate 24. Output is received on the output path 49 and drops into a receiving tray.

FIG. 2 illustrates a UV radiation means 58 for optionally cross linking the deposited solidified ink. Also shown is the optional integral business card cutting assembly 52 allowing the output of finished, cut business cards 55. This assembly can be easily removed as required for other non-business card jobs.

The entire flat surface (of the substrate) is eligible for raised printing by the coverage of the print head array perpendicularly arranged to the direction of movement of the substrate 24 through the device, and by the advancement of the substrate itself through the printer. The rate of advance of the substrate will be a function of the height of the raised effect desired and specified by the user. The raised area may comprise a number of layers of the phase change ink deposited one upon the other, by any suitable method known in those skilled in the art.

Accordingly, the spirit and broad scope of the appended claims is intended to embrace all such changes, modifications and variations that may occur to one of skill in the art upon a reading of the disclosure. All patent applications, patents and other publications cited herein are incorporated by reference in their entirety.

What is claimed is:

1. A method for creating raised printing effects on an image printed on a substrate, the method comprising: accepting a user indication of a section of primary phase change inkjet image printed using an offset deposition process on which to create the printing effects; specifying per the user indication a set of areas of the primary image to be printed with printing effects; specifying a height, relative to the medium, of the printing effects to be printed on the set of areas; a secondary phase change inkjet deposition directly jetted on top of the selected areas of the primary phase change inkjet image.

2. The method of claim 1, wherein said step of secondary depositing includes at least selectively adjusting the output from each of a plurality of phase change inkjet nozzles to control the amount of material dispensed from each nozzle.

3. The method of claim 2, comprising, in a continuously variable manner, adjusting the amount of phase change material to be deposited based the set of areas and the height.

4. The method of claim 1, comprising jetting the secondary phase change material in layers of pre-determined thickness.

5. The method of claim 1, further comprising the secondary depositing on the selected area with a clear or transparent phase change material allowing the primary image color to be seen.

6. The method of claim 1, wherein some or all of said phase change inkjet depositions include at least a color formed by combining individual different color jet depositions.

7. The method of claim 1, wherein the secondary depositing area is not on top of the primary depositing area.

8. The method of claim 1, further comprising the primary and secondary depositing are both directly jetted onto the substrate without using offset deposition.

9. The method of claim 7, further comprising the primary and secondary depositing are both directly jetted onto the substrate without using offset deposition.

10. The method of claim 1, wherein the primary image is printed with a printing process that is not a phase change inkjet.

11. The method of claim 7, wherein the primary image is printed with a printing process that is not a phase change inkjet.

12. The method of claim 1, wherein the substrate is heated to a temperature below that of the melted phase change ink in the printing apparatus.

13. The method of claim 7, wherein the substrate is heated to a temperature below that of the melted phase change ink in the printing apparatus.

14. The method of claim 1, wherein the raised printing apparatus has an integral business card cutter.

15. The method of claim 1, wherein the secondary depositing area is a pattern suitable for tactile communication such as Braille.

16. The method of claim 7, wherein the secondary depositing area is a pattern suitable for tactile communication such as Braille.

17. The method of claim 10, wherein the secondary depositing area is a pattern suitable for tactile communication such as Braille.

18. The method of claim 1, wherein the primary and or secondary deposited material can be a hot melt polymer that cross links, increasing the melting or softening temperature upon exposure to ultraviolet radiation.

19. The method of claim 1, where the phase change ink is configured to be a solid at temperatures below about 230° F. and to melt at a temperature above 230° F.

20. The method of claim 1, wherein the human machine interface is a computer.
